(19) United States
(12) Patent Application Publication
(10) Pub. No.: US 2005/0110767 A1
(43) Pub. Date: May 26, 2005

(54) Method of manufacturing touch sensor with switch tape strips

(75) Inventors: Paulo Irulegui Gomes, Redwood City, CA (US); Erling Hansen, Redwood City, CA (US); Ryo Tamaki, Clifton Park, NY (US); Mark W. Ellsworth, Dublin, CA (US); Richard Lloyd, Sunnyvale, CA (US)

Correspondence Address: Tyco Electronics Corporation;Suite 140, 4550 New Linden Hill Road, Wilmington, DE, 19808, US

(73) Assignee: Elo TouchSystems, Inc., Fremont, CA (US)

(21) Appl. No.: 10/720,438

(22) Filed: Nov. 24, 2003

(51) Int. Cl. G09G 5/00; B32B 7/12; B32B 15/04

(52) U.S. Cl. 345/173; 428/343

(57) ABSTRACT

The present invention is directed to touch sensors with arrays of switches (e.g., diodes or transistors) that can be used to selectively apply voltage gradients across a resistive touch regions of the touch sensor substrate. Touches on the touch sensor can then be sensed by measuring the voltage at the touch location on the resistive touch region. The switch arrays take the form of strips of switches that can be cut from a prefabricated reel or a sheet and applied to the touchscreen substrate.

### FIELD OF THE INVENTION

The field of the present invention relates to touch sensor technology, and more particularly to resistive and capacitive touch sensor technology.

### BACKGROUND OF THE INVENTION

Touch sensors are transparent or opaque input devices for computers and other electronic systems. As the name suggests, touch sensors are activated by touch, either from a user's finger, a stylus or some other device. Transparent touch sensors, and specifically touchscreens, are generally placed over display devices, such as cathode ray tube (CRT) monitors and liquid crystal displays, to create touch display systems. These systems are increasingly used in commercial applications such as restaurant order entry systems, industrial process control applications, interactive museum exhibits, public information kiosks, pagers, cellular phones, personal digital assistants, and video games.

The dominant touch technologies presently in use are resistive, capacitive, infrared, and acoustic technologies. Touchscreens incorporating these technologies have delivered high standards of performance at competitive prices. All are transparent devices that respond to a touch by transmitting the touch position coordinates to a host computer. An important aspect of touchscreen performance is a close correspondence between true and measured touch positions at all locations within a touch sensitive area located on the touch sensor.

Referring to FIG. 1, many resistive touchscreens 10 share the following mechanical components: a rigid insulative substrate 12 with a resistive coating 16 applied thereto; and a flexible membrane coversheet 14 with a conductive coating 18 applied thereto, wherein the flexible membrane is laid over the rigid substrate 12 with the two coatings opposed and separated by spacers 20 to avoid electrical contact between the two coatings until the membrane 14 is touched.

Many resistive touchscreens on the market are referred to as “4-wire” touchscreens. In 4-wire touchscreens, both the cover sheet and the rigid substrate are required to have resistive coatings of uniform resistivity. A voltage gradient on one coating is used to measure x-coordinates of touches, and a gradient on the other coating is used to measure y-coordinates of touches. For example, FIG. 2 illustrates a 4-wire touchscreen 30 that comprises a rigid substrate 32 and a flexible membrane coversheet 34, which are shown separately for purposes of clarity. The touchscreen 30 further comprises a uniform resistive coating 36 that is applied to the rigid substrate 32, and a uniform conductive coating 38 that is applied to the flexible cover sheet 34. A pair of wires 40(1) and 40(2) are connected to resistive coating 38 at the left and right edges of the cover sheet 34 via respective electrodes 42(1) and 42(2), and a pair of wires 40(3) and 40(4) are connected to resistive coating 36 at the top and bottom edges of the cover rigid substrate 32 via respective electrodes 42(3) and 42(4).

The x-coordinate of a touch can be measured by grounding wire 40(1), supplying voltage to wire 40(2), and connecting wires 40(3) and 40(4) to a voltage sensing circuit (not shown) that preferably has a high input impedance relative to the resistivity of the coatings 36 and 38. In a similar manner, the y-coordinate of a touch can be measured by grounding wire 40(3), supplying voltage to wire 40(4), and connecting wires 40(1) and 40(2) to the voltage sensing circuit. Significantly, accurate measurements of the x- and y-coordinates of a touch require the resistivity of both coatings 36 and 38 to be uniform and stable over time. However, the formation of cover sheets over spherically curved resistive touchscreens and the mechanical flexing of the cover sheet for both flat and curved resistive touchscreens tend to degrade the uniform resistivity of the coating on the cover sheet. For example, small cracks may form in the resistive coating. Because styluses generally have sharper radii than that of fingers, thus hastening the degradation process, the resistive coating degradation problem is an even greater concern in stylus-input devices.

Another type of commercially available resistive touchscreen is referred to as a “5-wire” touchscreen, which does not require the resistivity of the coating on the cover sheet to be uniform, since the x- and y-coordinates of touches are determined based on voltage gradients on the resistive coating of the rigid substrate. For example, FIG. 3 illustrates a 5-wire touchscreen 50 that comprises a rigid substrate 52 and a flexible membrane coversheet 54, which are shown separately for purposes of clarity. The touchscreen 50 further comprises a uniform resistive coating 56 that is laid over the rigid substrate 52, and a uniform resistive coating 58 that is laid over the flexible cover sheet 54. Four wires 60(1)-(4) are connected to the coating 56 at the respective corners of the rigid substrate 52 via respective electrodes 62(1)-(4), and a fifth wire 60(5) is connected to the coating 58 on one edge of the cover sheet 54 via an electrode 62(5). To ensure that a uniform voltage gradient is created along the coating 56 of rigid substrate 52, the touchscreen 50 further comprises four resistive networks 64(1)-(4) that are disposed on the coating 56 along the periphery of the rigid substrate 52.

The x-coordinate of a touch can be measured by grounding wires 60(1) and 60(2), and supplying voltage to wires 60(3) and 60(4). The voltage on the wire 60(5) connected to the cover sheet 54 is sensed by a high impedance voltage sensing circuit to determine the x-coordinate of the touch. The y-coordinate of a touch can be measured by grounding wires 60(2) and 60(3), and supplying voltage to wires 60(1) and 60(4). The voltage on the wire 60(5) is sensed by the voltage sensing circuit to determine the y-coordinate of the touch. Significantly, the resistivity of the coating 58 on the cover sheet 54 need not be uniform or stable with time and usage in order to obtain accurate measurements of the x- and y-coordinates of a touch. The coating 58 need only provide electrical continuity and have a resistance that is small compared to the input impedance of the voltage sensing circuit. Thus, the performance of 5-wire resistive touchscreens is generally not adversely affected by any degradation in the coating 58 of the cover sheet 54, and is therefore more reliable than the 4-wire resistive touchscreens. This benefit, however, does not come without a price, since the resistive networks required for 5-wire designs add complexity to the resistive touchscreen design and manufacturing process.

Another type of resistive touchscreen is referred to as a “3-wire” touchscreen, wherein voltage gradients are applied to the resistive coating of the rigid substrate using a network of diodes. For example, FIG. 4 illustrates a 3-wire touchscreen 70 that comprises a rigid substrate 72 and a flexible membrane coversheet 74, which are shown separately for purposes of clarity. The touchscreen 70 further comprises a uniform resistive coating 76 that is applied to the rigid substrate 72, and a uniform conductive coating 78 that is applied to the flexible cover sheet 74. A first wire 80(1) is connected to the coating 76 at the left edge of the rigid substrate 72 via a first array of diodes 82(1) and at the top edge of the rigid substrate 72 via a third array of diodes 82(3). A second wire 80(2) is connected to the coating 76 at the right edge of the rigid substrate 72 via a second array of diodes 82(2) and at the bottom edge of the rigid substrate 72 via a fourth array of diodes 82(4). A third wire 80(3) is connected to the coating 78 of the flexible cover sheet 74 on one edge of the cover sheet 74 via an electrode 84. The diodes 82 serve as switches that allow voltage gradients to be selectively applied to the coating 76 of the rigid substrate 72 in the x- and y-directions, depending on which of the wires 80 is energized.

In particular, the x-coordinate of a touch can be measured by grounding the second wire 80(2), and supplying a voltage to the first wire 80(1) sufficient to forward bias the diodes of the diode arrays 82(1) and 82(2) and to apply the desired voltage gradient. Notably, when this occurs, both the first and second diode arrays 82(1) and 82(2) will become forward biased (closed switches), and both the third and fourth diode arrays 82(3) and 82(4) will become reverse biased (open switches). As a result, current will flow from the first wire 80(1), through the forward biased diode array 82(1), across the resistive coating 76 in the x-direction, through the forward biased diode array 82(2), and to the second wire 80(2). The reverse biased diode arrays 82(3) and 82(4) will prevent current from flowing in the y-direction, thereby resulting in a uniform voltage gradient in the x-direction. The voltage on the wire 80(3) connected to the cover sheet 74 is sensed by a high impedance voltage sensing circuit to determine the x-coordinate of the touch.

Similarly, the y-coordinate of a touch can be measured by grounding the first wire 80(1), and supplying a voltage to the second wire 80(2) sufficient to forward bias the diodes of the diode arrays 82(3) and 82(4) and to apply the desired voltage gradient. Notably, when this occurs, both the third and fourth diode arrays 82(3) and 82(4) will become forward biased (closed switches), and the first and second diode arrays 82(1) and 82(2) will become reverse biased (open switches). As a result, current will flow from the second wire 80(2), through the forward biased diode array 82(4), across the resistive coating 76 in the y-direction, through the forward biased diode array 82(3), and to the first wire 80(1). The reverse biased diode arrays 82(1) and 82(2) will prevent current from flowing in the x-direction, thereby resulting in a uniform voltage gradient in the y-direction. Again, the voltage on the wire 80(3) is sensed by the voltage sensing circuit to determine the y-coordinate of the touch.

As illustrated in FIG. 4, the touchscreen 70 may employ an additional set of four wires 86(1)-86(4) for sensing the temperature dependent voltage drops across the diodes. In particular, the wires 86(1)-86(4) are respectively connected to the diode arrays 82(1)-82(4) at the connection to the resistive coating 76 of the substrate 72. The voltage sensing circuitry is connected to these wires 86(1)-86(4) to compensate for any abnormal voltage variances in the diodes. As long as the voltage drop on the diodes in a given array is the same, the voltage sensing circuitry can correct for temperature drifts in diode voltage drip, variations in excitation voltages, and any drift in the offset or gain of the analog-digital-converter (ADC) used to convert the measured analog voltages into digital signals. Such touchscreens have been referred to as “7-wire” touchscreens in the marketplace. We, however, reserve this term for the touchscreens described below.

Still another type of resistive touchscreen is referred to as a “7-wire” touchscreen, wherein voltage gradients are applied to the resistive coating of the rigid substrate using a network of transistors. For example, FIG. 5 illustrates a 7-wire touchscreen 90 that is similar to the previously described 3-wire touchscreen 70, with the exception that the touchscreen 90 employs field-effect transistors (FETs), rather than diodes, as switches. In particular, a first wire 92(1) is connected to the coating 76 at the left edge of the rigid substrate 72 via a first array of FETs 94(1) and at the top edge of the rigid substrate 72 via a third array of FETs 94(3). A second wire 92(2) is connected to the coating 76 at the right edge of the rigid substrate 72 via a second array of FETs 94(2) and at the bottom edge of the rigid substrate 72 via a fourth array of FETs 94(4). Four control wires 96(1)-96(4) are respectively connected to the gates of the FET arrays 92(1)-92(4). The x- and y-coordinates of a touch can be measured by supplying a voltage to the first wire 92(1) to allow current to flow in the FETs when the gates are energized and grounding the second wire 92(2), while selectively energizing and grounding the wires 96(1)-96(4).

In particular, the x-coordinate of a touch can be measured by supplying a sufficient voltage to the control wires 96(1) and 96(2) to “turn on” the FETs in arrays 94(1) and 94(2), and grounding the control wires 96(3) and 96(4) to “turn off” the FETs in arrays 94(3) and 94(4). As a result, current will flow from the first wire 92(1), through the turned-on FET array 94(1), across the resistive coating 76 in the x-direction, through the turned-on FET array 94(2), and to the second wire 92(2). The turned-off FET arrays 94(3) and 94(4) will prevent current from flowing in the y-direction, thereby resulting in a uniform voltage gradient in the x-direction. The voltage on the wire 80(3) connected to the cover sheet 74 is sensed by a high impedance voltage sensing circuit to determine the x-coordinate of the touch.

Similarly, the y-coordinate of a touch can be measured by supplying a sufficient voltage to the control wires 96(3) and 96(4) to “turn on” the FETs in arrays 94(3) and 94(4), and grounding the control wires 96(1) and 96(2) to “turn off” the FETs in arrays 94(1) and 94(2). As a result, current will flow from the first wire 92(1), through the turned-on FET array 94(3), across the resistive coating 76 in the y-direction, through the turned-on FET array 94(4), and to the second wire 92(2). The turned-off FET arrays 94(1) and 94(2) will prevent current from flowing in the x-direction, thereby resulting in a uniform voltage gradient in the y-direction. The voltage on the wire 80(3) connected to the cover sheet 74 is sensed by a high impedance voltage sensing circuit to determine the y-coordinate of the touch.

Significantly, the 3-wire and 7-wire resistive touchscreen designs are simplistic and do not require the resistivity of the coating 78 to be uniform or stable over time. In addition, the 3-wire and 7-wire resistive designs avoid the complex and carefully tuned resistor networks of the 5-wire resistive touchscreens. Thus, it can be appreciated that either of the 3-wire and 7-wire resistive designs combines the advantages of both the 4-wire and 5-wire resistive designs. At present, however, 3-wire and 7-wire resistive touchscreens have not gained commercial acceptance, mainly because no one has developed a low-cost means to mount the diodes or transistors onto the rigid substrate, which otherwise would involve hours of manual soldering of many discrete components onto the substrate.

As such, there remains a need to provide an improved means for mounting arrays of solid state switches, such as diodes and transistors, onto touchscreen substrates.

### SUMMARY OF THE INVENTION

In accordance with a first aspect of the present invention, a method of manufacturing a touch sensor is provided. The method comprises providing a substrate having a resistive touch region. In the preferred embodiment, the substrate is rigid, although the substrate can also be flexible in some cases. The resistive touch region is preferably rectangular, although other types of geometries are contemplated by the present invention, depending upon the application of the touch sensor.

The method further comprises providing a tape strip with a plurality of devices. Each of the devices has first and second terminals and is configured to allow electrical current conduction from the first terminal to the second terminal when in a first state, and prevent electrical current conduction from the second terminal to the first terminal when in a second state. Diodes and transistors are examples of devices that can perform this function. The method further comprises securing the tape strip along an edge of the resistive touch region, wherein one of the first and second terminals of the devices are in electrical contact with the resistive touch region. Preferably, the method comprises securing an electrically conductive lead to the other of the first and second terminals. In one preferred embodiment, the devices are surface mounted devices. In another preferred embodiment, the devices are thin-film devices, e.g., conductive polymer devices.

In accordance with a second aspect of the present invention, another method of manufacturing a touch sensor is provided. The method comprises providing a substrate having a resistive touch region with first and second oppositely disposed edges and third and fourth oppositely disposed edges, and providing four tape strips. Each of the tape strips comprises a plurality of devices similar to those previously described. The method further comprises securing two of the tape strips along the respective first and third edges of the resistive touch region, and the other two strips along the respective second and fourth edges of the resistive touch region. The second terminals of the devices on the first two tape strips are in electrical contact with the resistive touch region, and the first terminals of the devices on the remaining two tape strips are in electrical contact with the resistive touch region. In the preferred embodiment, at least one electrically conductive lead is coupled to the first terminals of devices not connected to the touch region, and at least another electrically conductive lead is connected to the second terminals of devices not connected to the touch region. The tape strips may be advantageously supplied in a tape reel or as a sheet, in which case the tape strips can be cut therefrom.

In accordance with a third aspect of the present invention, reversible diode tape is provided. The diode tape comprises a first electrically insulative layer, a layer of spaced apart anodes disposed on the first electrically insulative layer, a p-type semiconductor layer disposed on the anode layer, an n-type semiconductor layer disposed on the p-type semiconductor layer, a layer of spaced apart cathodes disposed on the n-type semiconductor layer, wherein the cathodes are substantially aligned with the anodes to discretely form diodes, and a second electrically insulative layer disposed on the cathode layer. In one embodiment, the semiconductor layers are composed of conductive polymer, such as doped polythiophene, poly (3,4-ethylenedioxythiophene)-poly(4-styrenesulfonate) and doped poly(2-methoxy,5-(2′-ethyl-hexyloxy)-1,4-phenylene vinylene).

In the preferred embodiment, a layer of exposed anode terminals are respectively disposed on the anode layer, and a layer of exposed cathode terminals are respectively disposed on the layer of cathodes. For example, the anode and cathode terminals can respectively extend along the opposite edges of the tape. Thus, it can be appreciated that the reversible diode tape can be used to conduct current in a selected one of two directions, depending on which side of the diode tape is bonded to the touchscreen substrate. The diode tape may optionally comprise a first electrically conductive trace connecting the anodes, and a second electrically conductive trace connecting the cathodes. In this case, one of the conductive traces can be subsequently etched to either disconnect the cathodes from each other or disconnect the anodes from each other, when the diode tape is bonded to a touchscreen substrate.

### BRIEF DESCRIPTION OF THE DRAWINGS

The drawings illustrate the design and utility of preferred embodiment(s) of the present invention, in which similar elements are referred to by common reference numerals. In order to better appreciate the advantages and objects of the present invention, reference should be made to the accompanying drawings that illustrate the preferred embodiment(s). The drawings depict only an embodiment(s) of the invention, and should not be taken as limiting its scope. With this caveat, the preferred embodiment(s) will be described and explained with additional specificity and detail through the use of the accompanying drawings in which:

FIG. 1 is a cross-section of a prior art touchscreen;

FIG. 2 is a plan view of a prior art “4-wire” touchscreen;

FIG. 3 is a plan view of a prior art “5-wire” touchscreen;

FIG. 4 is a plan view of a prior art “3-wire” touchscreen;

FIG. 5 is a plan view of a prior art “7-wire” touchscreen;

FIG. 6 is a block diagram of a touchscreen system constructed in accordance with one embodiment of the present invention;

FIG. 7 is a perspective view of a 3-wire touchscreen used in the touchscreen system of FIG. 6;

FIG. 8 is a perspective view of a surface mounted diode array strip used to fabricate the touchscreen of FIG. 7;

FIG. 9 is a perspective view of another surface mounted diode array strip that can be used to fabricate the touchscreen of FIG. 7;

FIG. 10 is a perspective view of a tape reel from which the diode array strip of FIG. 8 can be cut;

FIG. 11 is a plan view of a sheet from which the diode array strip of FIG. 8 can be cut;

FIGS. 12-18 are plan views illustrating a preferred method of fabricating a thin-film diode array strip that can alternatively be used in the touchscreen of FIG. 7;

FIG. 18a is a cross-sectional view of the diode array strip illustrated in FIG. 18, taken along the line 18a-18a;

FIG. 19 is a cross-sectional view showing the placement of the diode array strip of FIG. 18 on a touchscreen substrate to create a touchscreen;

FIGS. 20-23 are plan views illustrating another preferred method of fabricating a thin-film diode array strip that can alternatively be used in the touchscreen of FIG. 7;

FIG. 23a is a cross-sectional view of the diode array strip illustrated in FIG. 23, taken along the line 23a-23a;

FIG. 24 is a cross-sectional view showing the placement of the diode array strip of FIG. 23 on a touchscreen substrate to create a touchscreen;

FIGS. 25-31 are plan views illustrating a preferred method of fabricating reversible diode tape for use in the touchscreen of FIG. 7;

FIG. 28a is a cross-sectional view of the diode array strip illustrated in FIG. 28, taken along the line 28a-28a;

FIG. 29a is a cross-sectional view of the diode array strip illustrated in FIG. 29, taken along the line 29a-29a;

FIG. 30a is a cross-sectional view of the diode array strip illustrated in FIG. 30, taken along the line 30a-30a;

FIG. 31a is a cross-sectional view of the diode array strip illustrated in FIG. 31, taken along the line 31a-31a;

FIG. 32 is a plan view of a 7-wire touchscreen that can alternatively be used in the touchscreen system of FIG. 6;

FIG. 33 is a perspective view of a surface mounted transistor array strip that can be used to fabricate the touchscreen of FIG. 32;

FIGS. 34-41 are plan views illustrating a preferred method of fabricating a thin-film transistor array strip that can be used in the touchscreen of FIG. 32;

FIG. 41a is a cross-sectional view of the transistor array strip illustrated in FIG. 41, taken along the line 41a-41a; and

FIG. 42 is a cross-sectional view showing the placement of the transistor array strip of FIG. 41 on a touchscreen substrate to create a touchscreen.

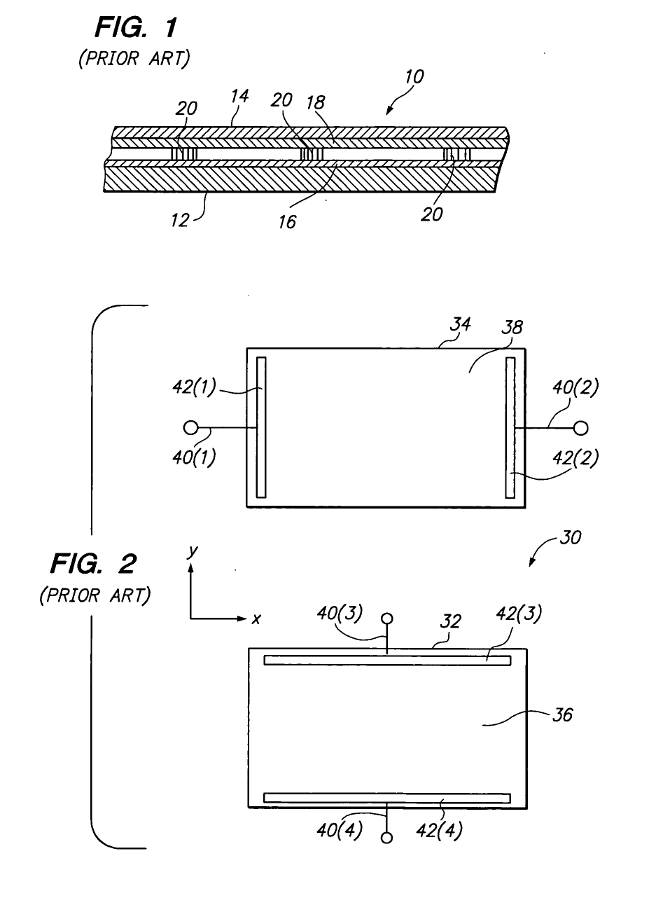

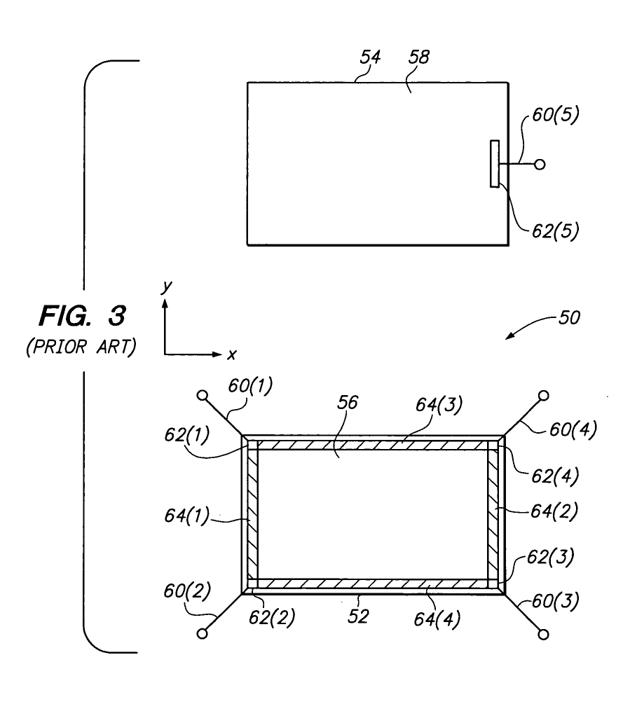

### DETAILED DESCRIPTION OF THE PREFERRED EMBODIMENTS

Referring to FIG. 6, a resistive touchscreen system 200 constructed in accordance with a preferred embodiment of the present invention is described. The touchscreen system 200 generally comprises a touchscreen 205 (i.e., a touch sensor having a transparent substrate), controller electronics 210, and a display (not shown). The touchscreen system 200 is typically coupled to a host computer 215. Generally, the controller electronics 210 send excitation signals to the touchscreen 205 and receive analog signals carrying touch information from the touchscreen 205. Specifically, the controller electronics 210 establish voltage gradients across the touchscreen 205. The voltages at the point of contact are representative of the position touched. The controller electronics 210 digitize these voltages and transmit these digitized signals, or touch information in digital form based on these digitized signals, to the host computer 215 for processing.

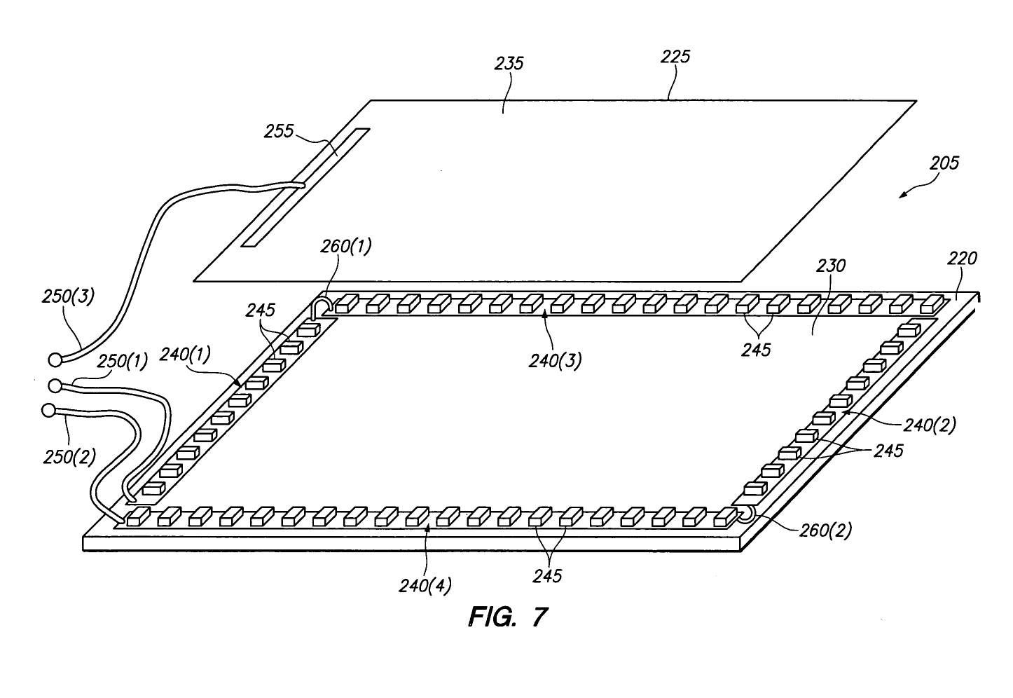

Referring now to FIG. 7, the touchscreen 205 comprises a rigid substrate 220 having a resistive touch region 230 that is formed by permanently applying a uniform resistive layer to one surface of the substrate 220. The touchscreen 205 further comprises a plastic coversheet 225 having a conductive layer 235 applied thereto. Generally, orthogonal voltage gradients will be alternately applied over the resistive touch region 230 of the touchscreen 205 via diodes 245 arranged along the respective four edges of the touchscreen 205 as four diode arrays (a left diode array 240(1), a right diode array 240(2), a top diode array 240(3), and a bottom diode 240(4)). The touchscreen system 200 employs a 3-wire architecture, and thus, a first electrically conductive lead 250(1) connects the left and top diode arrays 240(1) and 240(3) to the controller electronics 210, and a second electrically conductive lead 250(2) connects the right and bottom diode arrays 240(2) and 240(4) to the controller electronics 210. A third electrically conductive lead 250(3) connects the conductive layer 235 of the coversheet 225 to the controller electronics 210 via an electrode 255.

When the touchscreen 205 is pressed, the conductive coating 235 of the cover sheet 225 makes direct electrical contact with the resistive touch region 230 on the substrate 220. For a quasi-DC resistive touchscreen, commonly referred to as a “resistive touchscreen,” the cover sheet 225 can function as either a voltage sensing probe for sensing the voltage at the contacted area, or as a current injection source. As another option, the coversheet 225 may be replaced with a thin dielectric coating applied directly to resistive layer of the touch region 230, in which case, the controller electronics 210 may support AC operation.

The topology of the touchscreen 205 is similar to that of the touchscreen 70 previously described above. That is, the x-coordinate of a touch on the touchscreen 205 can be determined by applying a voltage to the first lead 250(1), grounding the second lead 250(2), and sensing the voltage on the third lead 250(3). Likewise, the y-coordinate of a touch on the touchscreen 205 can be determined by grounding the first lead 250(1), applying a voltage to the second lead 250(2), and sensing the voltage on the third lead 250(3). Here, the term “ground” refers to a low voltage or local ground at the touchscreen 105, which may or may not correspond to other grounds of the system.

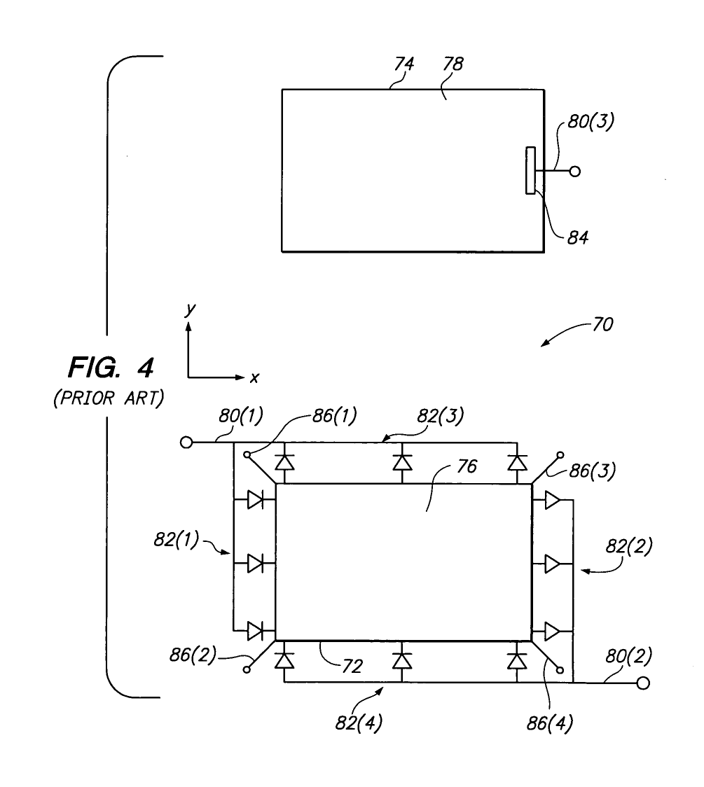

As will be discussed in further detail below, the diode arrays 240 are applied to the touchscreen substrate 220 as tape strips that are suitably adhered to the resistive touch region 230 of the substrate 220. During the fabrication process, it should be appreciated that the electrical connection of the anode and cathodes will depend on the particular location of the diode array 240 on the substrate 220. In particular, the left diode array 240(1) will be applied to the substrate 220, such that the cathodes and anodes are in respective electrical contact with the resistive touch region 230 and first lead 250(1) (see diode array 82(1) in FIG. 4). Similarly, the bottom diode array 240(4) will be applied to the substrate 220, such that cathodes and anodes are in respective electrical contact with the resistive touch region 230 and second lead 250(2) (see diode array 82(4) in FIG. 4). In contrast, the right diode array 240(2) will be applied to the substrate 220, such that anodes and cathodes are in respective electrical contact with the resistive touch region 230 and the second lead 250(2) (see diode array 82(2) in FIG. 4). Similarly, the top diode array 240(3) will be applied to the substrate 220, such that the anodes and cathodes are in respective electrical contact with the resistive touch region 230 and the first lead 250(1) (see diode array 72(3) in FIG. 4). As a result of these specific connections, the current will flow across the resistive touch region 230 in the desired orthogonal directions, in the same manner described in the touchscreen 70 of FIG. 4, when the leads 250(1) and 250(2) are alternately energized and grounded.

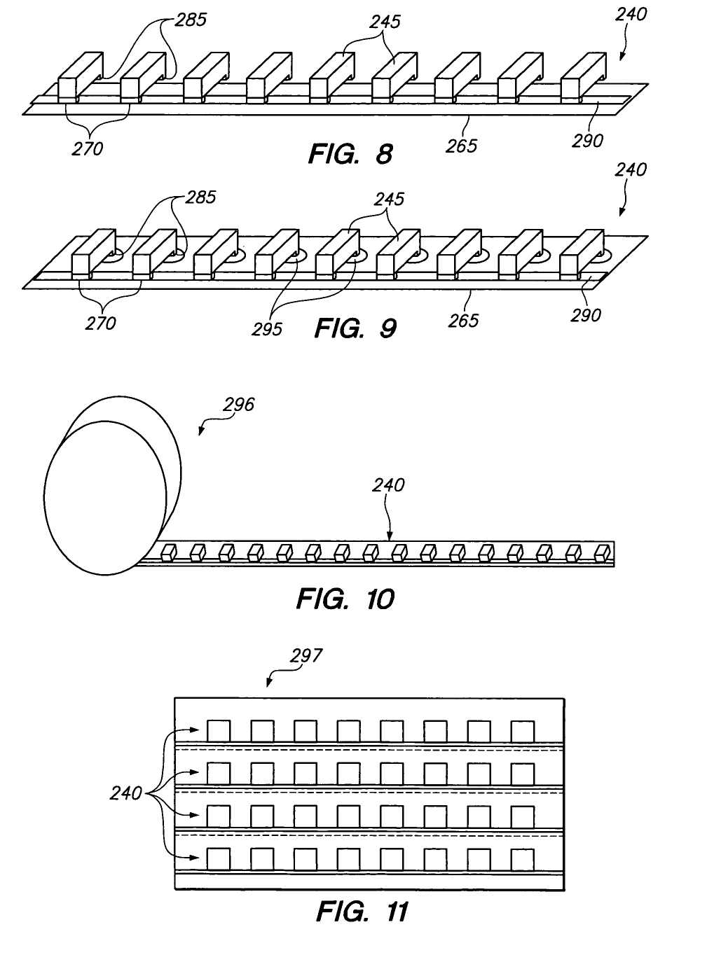

With further reference to FIG. 8, each diode strip 240 comprises an insulative tape strip 265 composed of a suitable material, such as polyester (e.g., Mylar®) or polyimide (e.g., Kapton®), and a plurality of diodes, and specifically standard surface mounted diodes 245, mounted along the length of the tape strip 265. Each diode 245 comprises an anode terminal 270 and a cathode terminal 285. The diode strip 240 further comprises an electrically conductive trace 290 that extends off center along the length of tape strip 265 and electrically connects the diodes 245 together.

In the diode strip 240 illustrated in FIG. 8, the anode terminal 270 of each diode 245 is soldered to the conductive trace 290, and the cathode terminal 285 of each diode 245 is exposed, so that it can be soldered or glued to the resistive touch region 230 of the substrate 220. The cathode terminals 285 extend over the edge of the tape strip 265 to provide clearance for mounting to the exposed touch region 230. Alternatively, holes or vias 295 can be provided through the tape strip 265 (as illustrated in FIG. 9), so that the cathode terminals 285 can be connected to the resistive touch region 230 through the holes or vias 295. Advantageously, the use of holes or vias 295 may also prevent solder migration. Notably, either of the diode strips 240 illustrated in FIGS. 8 and 9 can be applied to the substrate 220 along the left and bottom peripheral edges of the resistive touch region 230 to form the diode arrays 240(1) and 240(4). A diode strip similar to the diode strips 240 illustrated in FIGS. 8 and 9, with the exception that the anodes and cathodes are switched, can be applied to the substrate 220 along the right and top peripheral edges of the resistive touch region 230 to form the diode arrays 240(2) and 240(3). The diode strip 240 may optionally comprise additional electrically conductive traces (not shown), e.g., in order to sense temperature dependent voltage drops across the diodes (see FIG. 4).

It can be appreciated that the use of diode strips 240 simplifies the fabrication process, since the diode strips 240 may be manufactured separately using standard automated processes. The use of diode strips 240 also allows touchscreen designers to more easily introduce touch capability on non-conventional surfaces, such as ubiquitous computing applications.

In the preferred embodiment, the diode strips 240 are supplied as a tape reel 296, as illustrated in FIG. 10. The touchscreen designer need only cut the diode strips 240, which are sized to the respective edges of the touchscreen 205, from the tape reel 296. Alternatively, the diode strips 240 may be supplied as a sheet 297, as illustrated in FIG. 11. In this case, the touchscreen designer need only cut the sheet 297 (along the dashed lines) to provide the required diode strips 240. Differently sized sheets 297 can be used, depending on the length of the edge on which the cut diode strip 240 will be mounted. Whether the diode strips 240 are cut from a tape reel or a sheet, the use of two different tape reels or sheets having different directions of current conduction (one for the diode arrays 240(1) and 240(4), and the other for the diode arrays 240(2) and 240(3)) will be required for each fabricated touchscreen.

After the diode strips 240 have been properly measured and cut, the diode strips 240 can then be bonded to the touchscreen substrate 220, as illustrated in FIG. 7. Using a suitable electrically conductive adhesive, the cathodes 285 of the left and bottom diode arrays 240(1) and 240(4), and the anodes 270 of the right and top diode arrays 240(2) and 240(3), can be connected to the resistive touch region 230. Electrically conductive leads 250(1) and 250(2) can then be respectively soldered to the electrical traces 290 of the left and bottom diode arrays 240(1) and 240(4) at the bottom left corner of the touchscreen 205. A first jumper wire 260(1) is used to connect the electrical traces 290 of the left and top diode arrays 240(1) and 240(3) together, and a second jumper wire 260(2) is used to connect the electrical traces 290 of the right and bottom diode arrays 240(2) and 240(4) together.

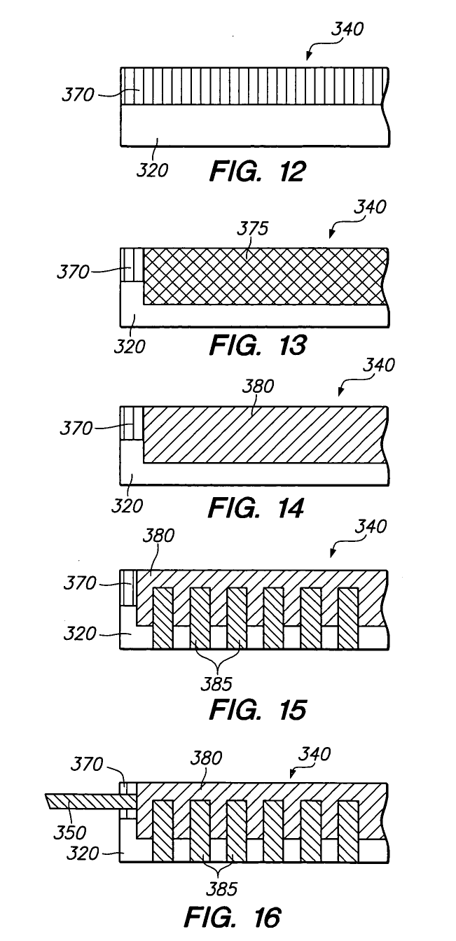

Although the diodes in the diode strips 240 of FIG. 7 are illustrated and described as surface mounted diodes, diode strips with thin-film diodes can also be used. For example, FIGS. 12-19 illustrate a process for fabricating and mounting a diode strip 340 onto a touchscreen substrate using conductive polymer technology.

First, a layer of anode material 370, e.g., copper, is disposed onto a flexible insulative layer 320, such as polyester (e.g., Mylar®) or polyimide (e.g., Kapton®) (FIGS. 12 and 18a). Next, a layer of p-type conductive polymer 375 is deposited over the anode layer 370 (FIGS. 13 and 18a). In the preferred embodiment, the p-type conductive polymer layer 375 is composed of polythiophene, poly (3,4-ethylenedioxythiophene)-poly(4-styrenesulfonate) (PEDOT-PSS) that is coated onto the anode layer 370. Alternatively, other electrically conductive polymers can be used, such as acetylenes, thiophenes, phenylenes, pyrroles, or a combination thereof. Next, a layer of n-type conductive polymer 380 is deposited over the p-type conductive polymer layer 375 (FIGS. 14 and 18a). In the preferred embodiment, the n-type conductive polymer layer 380 is composed of poly(2-methoxy,5-(2′-ethyl-hexyloxy)-1,4-phenylene vinylene) (MEH-PPV) that is coated onto the p-type conductive polymer 375. Next, a layer of cathode material 385, e.g., aluminum, is deposited over the n-type conductive polymer 380 (FIGS. 15 and 18a). As can be seen, the cathode layer 385 is segmented into an array of cathode elements to form discrete diodes. As with the diode strips 240 illustrated in FIGS. 8 and 9, this step can advantageously be performed separately from the touchscreen fabrication process using standard automated processes, with the resulting tape supplied in the form of a reel or a sheet.

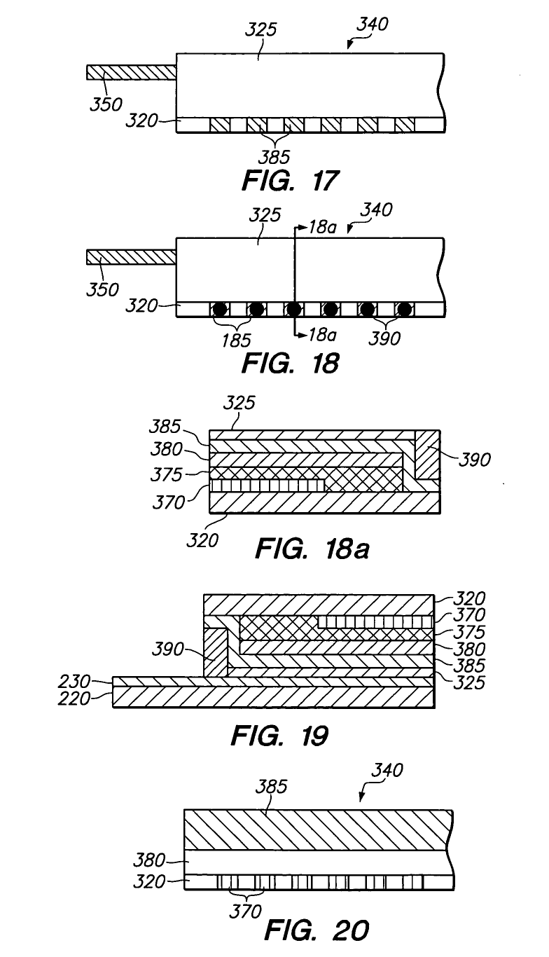

Next, an electrically conductive lead 350, e.g., copper tape or wire, is soldered or otherwise bonded to the anode layer 370 (FIGS. 16 and 18a). Then, another flexible insulative layer 325, such as, e.g., polyimide, is applied over the subassembly (FIGS. 17 and 18a). Alternatively, the subassembly can be encapsulated using a suitable material, such as electrical grade epoxy resin. In this case, the flexible insulative layer 325 serves as both an insulator and an encapsulator. As illustrated in FIG. 17, a portion of the cathode layer 385 is left exposed. Cathode terminals 390 can then be fabricated onto the exposed portions of the cathode layer 385 using a suitable electrically conductive material, such as copper tape, conductive tape/gel, or lead solder (FIGS. 18 and 18a). Next, the diode strip 245 is mounted onto the resistive touch region 230 of the substrate 220 using a suitable adhesive (FIG. 19), with the insulating layer 325 abutting the resistive touch region 230. As can be seen in FIG. 19, the cathode layer 385 is electrically connected to the resistive touch region 230 of the substrate 220 via the cathode terminals 390 and the resistive layer 230.

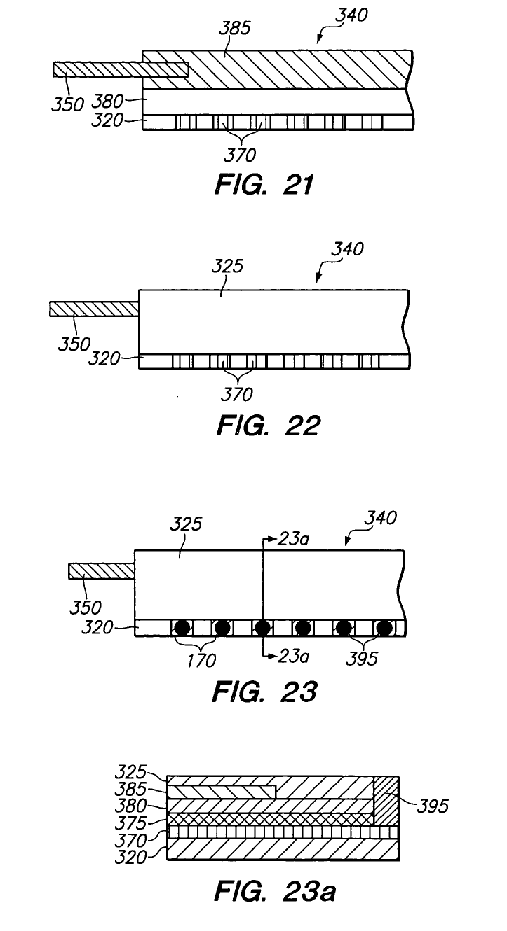

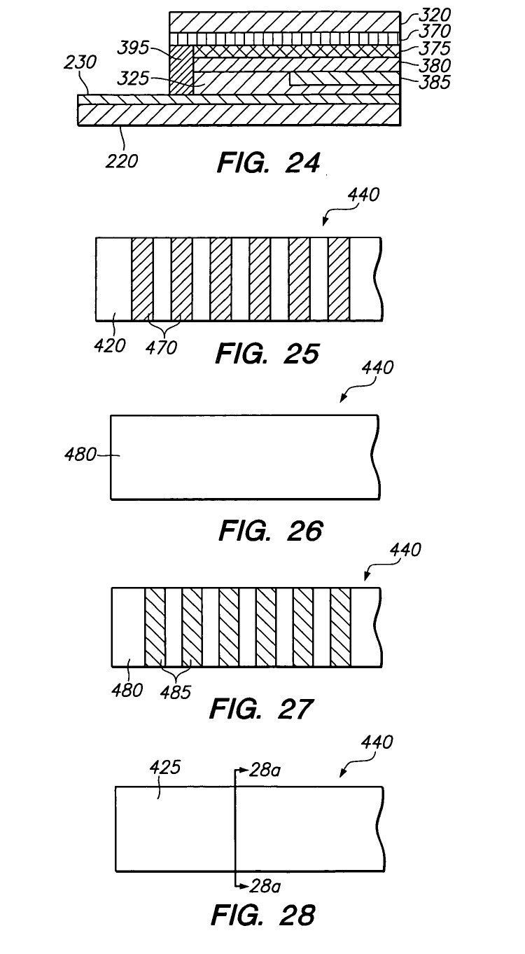

Referring to FIGS. 20-24, diode strips 340 with the opposite current direction can be prepared simply by applying the anode layer 370 to the flexible insulating layer 320, with the anode layer 370 arranged into strips to form discrete anode elements, and repeating the p-type conductive polymer 375, n-type conductive polymer 380, and then cathode layer 385 application steps (FIGS. 20 and 23a). Next, an electrically conductive lead 350 is soldered or otherwise bonded to the cathode layer 385 (FIG. 21). Then, the other flexible insulative layer 325 is applied over the subassembly (FIGS. 22 and 23a), or alternatively, the subassembly can be encapsulated. Anode terminals 395 are then fabricated onto exposed portions of the anode layer 370 (FIGS. 23 and 23a), and then the diode strip 340 is suitably mounted to the resistive touch region 230 of the substrate 220 (FIG. 24).

Alternatively, the diode strip 340 illustrated in FIG. 18 can be fabricated by reversing the application order of the anode layer 370, p-type conductive polymer layer 375, n-type conductive polymer layer 380, and cathode layer 385, with the electrically conductive lead 350 coupled to the cathode layer 385 and anode terminals coupled to the anode layer 370. The reverse order diode strip 340 can then be mounted to the resistive touch region 230 of the substrate 220, with the anode terminals in contact with the resistive touch region 230. Likewise, the diode strip 340 illustrated in FIG. 23 can be fabricated by reversing the application order of the anode layer 370, p-type conductive polymer layer 375, n-type conductive polymer layer 380, and cathode layer 385, with the electrically conductive lead 350 coupled to the anode layer 370 and anode terminals coupled to the cathode layer 385. The reverse order diode strip 340 can then be mounted to the resistive touch region 230 of the substrate 220, with the cathode terminals in contact with the resistive touch region 230.

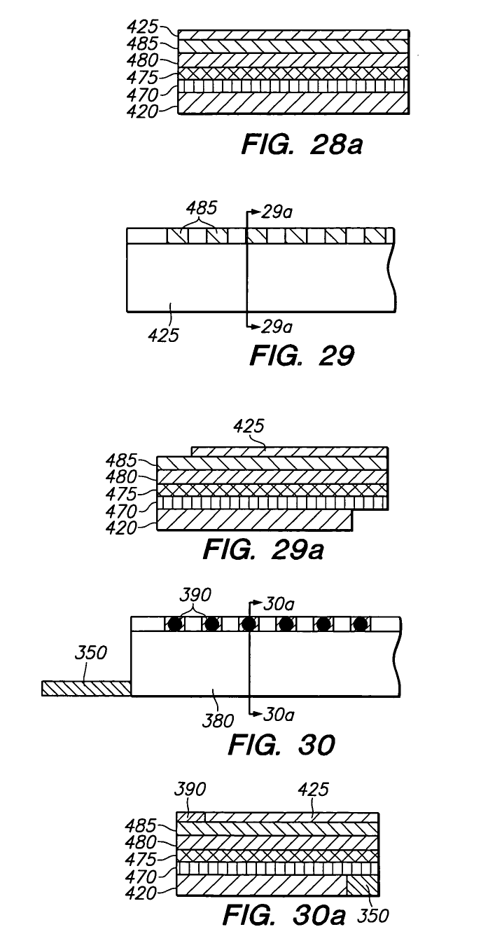

As previously mentioned, when using the diode strips 240 and 340 to fabricate touchscreens, two types are required. The first type conducts current in a first direction (for the left and bottom diode arrays), and the second type conducts current in a second direction (for the right and top diode arrays). FIGS. 25-30 illustrate a fabrication process that produces a reversible diode strip 440 that can be used to conduct current in either of the directions, depending on how it is applied to the touchscreen substrate. In particular, an anode layer 470 (divided into anode elements) is first applied to a flexible insulative layer 420 (FIGS. 25 and 28a). Next, a p-type conductive polymer 475 is applied over the anode layer 470, and then an n-type conductive polymer 480 is applied over the p-type conductive polymer 475 (FIGS. 26 and 28a). Then, a cathode layer 485 (divided into cathode elements that are aligned with the underlying anode elements) is applied to the n-type conductive polymer 480 (FIGS. 27 and 28a). Next, another flexible insulative layer 425 is applied over the cathode layer 485 (FIGS. 28 and 28a). Then, a portion of the insulative layer 420 adjacent one lateral edge of the strip, and a portion of the insulative layer 425 adjacent the other lateral edge of the strip, are both etched away to expose the respective edges of the anode and cathode layers 470 and 485 (FIGS. 29 and 29a).

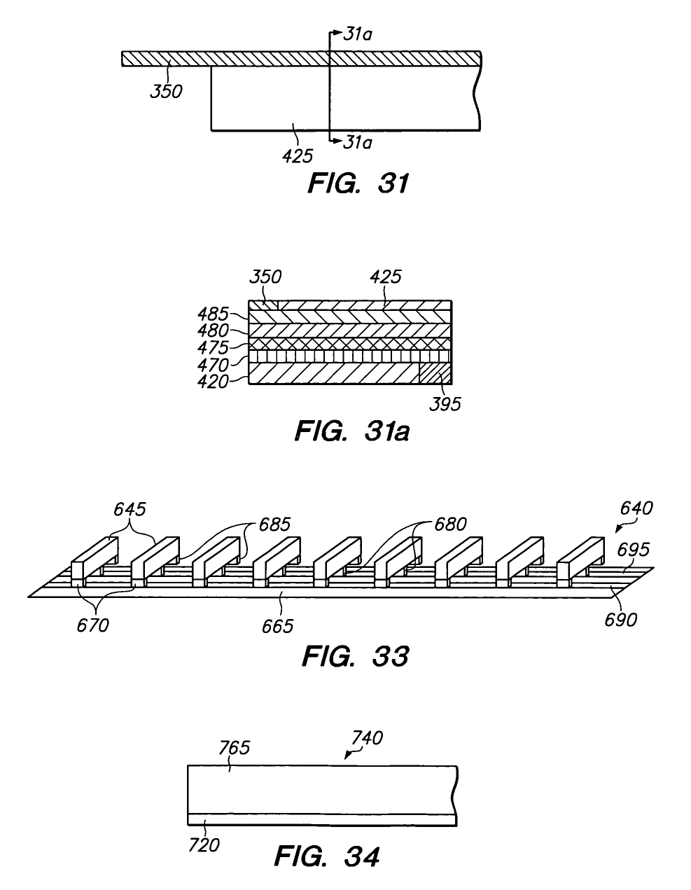

Like the previously described diode strips 240 and 340, the reversible diode strip 440 illustrated in FIG. 29 can be supplied in reel or sheet form. The diode strips 440 can be cut to length, and then applied to the substrate 220 along the respective edges of the resistive touch region 230 (shown in FIG. 7). The electrical connections between the diode strips 440 and the substrate 220 will depend on which edge of the resistive touch region 230 that respective diode strip 440 will be applied to. For example, if the diode strip 440 is designed to take the form of a left or bottom diode array, an electrically conductive lead 350 may be soldered across the exposed portions of the anode layer 470, and cathode terminals 390 may be applied to the exposed portions of the cathode layer 485 (FIGS. 30 and 30a). In contrast, if the diode strip 440 is designed to take the form of a right or top diode array, an electrically conductive lead 350 may be soldered across the exposed portions of the cathode layer 485, and anode terminals 395 may be applied to the exposed portions of the anode layer 470 (FIGS. 31 and 31a).

In an alternative diode tape fabrication process, the anode and cathode elements of the respective anode and cathode layers 470 and 485 can be coupled together lithographically or using electrically conductive tape prior to placing the diode tape in reel or sheet form. When mounting the cut diode strips to the touchscreen substrate, the cathode elements can be electrically isolated by etching the connections between the elements, and the electrically conductive lead 350 can then be coupled to the anode layer (in the case of left and bottom diode arrays), or the anode elements can be electrically isolated by etching the connections between the elements, and the electrically conductive lead 350 can then be coupled to the cathode layer (in the case of right and top diode arrays). The diode strips can then be suitably bonded on the substrate along the respective edges of the resistive touch region.

Further details regarding the fabrication of diode arrays using conductive polymer technology are set forth in further detail in U.S. patent application Ser. No. ______ (Attorney docket number ELG056 US1), which is expressly incorporated herein by reference.

Although the diode arrays 240, 340, and 440 have been described as comprising two semiconductor materials (a p-type semiconductor material and an n-type semiconductor material), it should be noted that diode arrays can be fabricated using a single type of semiconductor material. For example, diode arrays formed from Schottky diodes, which typically utilize one layer of a semiconductor material, can be used. For example, the previously described diode strips 340 and 440 can use a single conductive polymer layer between anode and cathode layers. Or the diode strip 240 can carry surface mounted Schottky diodes.

It can be appreciated that the previously described diodes can be characterized as switching devices that can be switched between first and second states. In particular, each diode is configured to allow electrical current conduction from a first terminal (anode) to the second terminal (cathode) when in a first state (diode is forward biased), and prevent electrical current conduction from the second terminal to the first terminal when in a second state (diode is reverse biased).

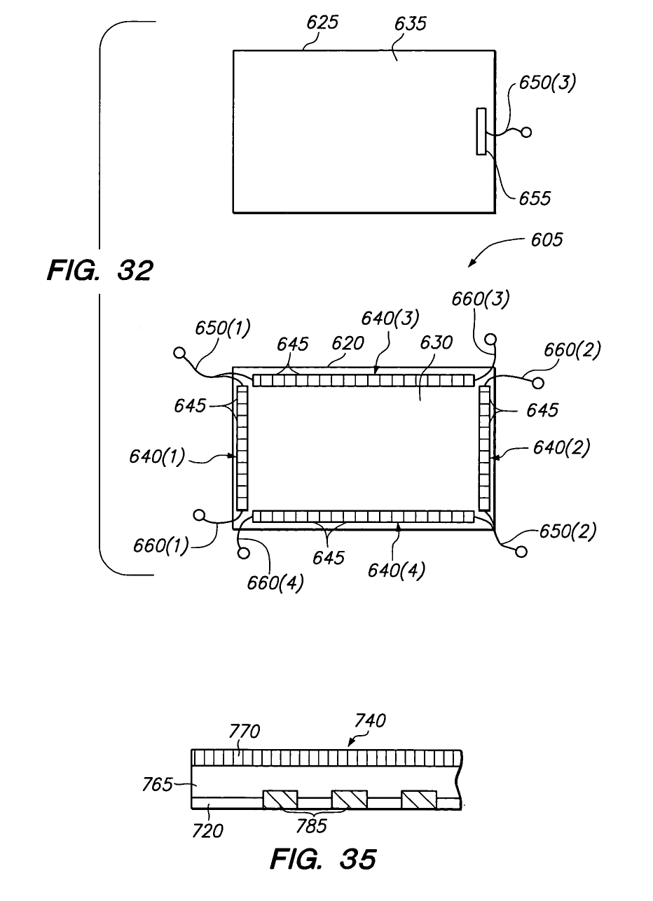

Other types of solid-state devices, such as field-effect transistors (FETs), can be used as switching devices instead. That is, each FET is configured to allow electrical current conduction from a first terminal (source) to the second terminal (drain) when in a first state (FET is on), and prevent electrical current conduction from the second terminal to the first terminal when in a second state (FET is off). For example, FIG. 32 illustrates a touchscreen 605 that uses transistors, and specifically, field-effect transistors (FETs), as switches for applying the desired voltage gradients across the touchscreen. In particular, the touchscreen 605 comprises a rigid substrate 620 having a resistive touch region 630, a coversheet 625 having a resistive layer 635, and a plurality of transistors 645 arranged along the respective four edges of the touchscreen 605 as four transistor arrays 640 (a left transistor array 640(1), a right transistor array 640(2), a top transistor array 640(3), and a bottom transistor array 640(4)).

In this case, the touchscreen system 200 employs a 7-wire architecture, and thus, a first electrically conductive lead 650(1) connects transistor arrays 640(1) and 640(3) to the controller electronics 210, and a second electrically conductive lead 650(2) connects the transistor arrays 640(2) and 640(4) to the controller electronics 210. A third electrically conductive lead 650(3) connects the resistive layer 635 of the coversheet 625 to the controller electronics 210 via an electrode 655. Four electrically conductive control leads 660(1)-660(4) are also connected between the respective transistors arrays 640(1)-640(4) and the controller electronics 210 in order to turn the respective transistors on and off.

The topology of the touchscreen 605 is similar to that of the touchscreen 90 previously described above. That is, the x-coordinate of a touch on the resistive touch region 630 can be determined by applying a voltage to the first lead 650(1), grounding the second lead 650(2), turning the left and right transistor arrays 640(1) and 640(2) on by applying a voltage to the first and second control leads 660(1) and 660(2), turning the top and bottom transistor arrays 640(3) and 640(4) off by grounding the third and fourth control leads 660(3) and 660(4), and sensing the voltage on the third lead 650(3). Likewise, the y-coordinate of a touch on the resistive touch region 630 can be determined by applying a voltage to the first lead 650(1), grounding the second lead 650(2), turning the left and right transistor arrays 640(1) and 640(2) off by grounding the first and second control leads 660(1) and 660(2), turning the top and bottom transistor arrays 640(3) and 640(4) on by applying a voltage to the third and fourth control leads 660(3) and 660(4), and sensing the voltage on the third lead 650(3).

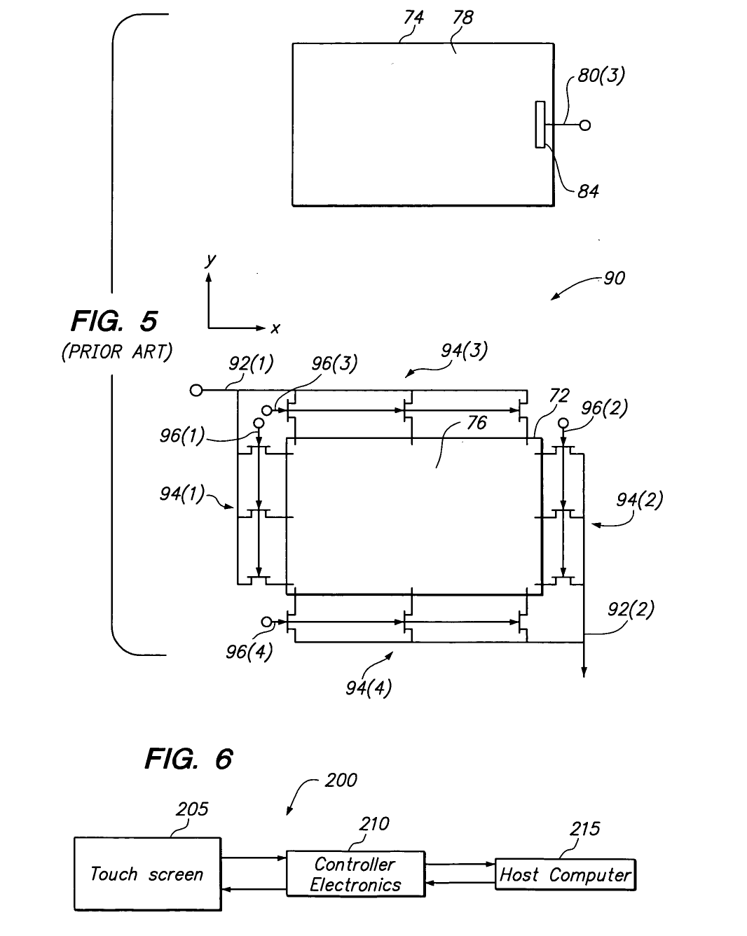

During the fabrication process, it should be appreciated that the electrical connection of the sources and drains of the transistors arrays 640 will depend on the particular location of the transistor array 640 on the substrate 620. In particular, the left transistor array 640(1) will be applied to the substrate 620, such that the drains and sources are in respective electrical contact with the resistive touch region 630 and the first lead 650(1) (see transistor array 94(1) in FIG. 5). Similarly, the top transistor array 640(3) will be applied to the substrate 620, such that the drains and sources are in respective electrical contact with the resistive touch region 630 and the first lead 650(1) (see transistor array 92(3) in FIG. 5). In contrast, the right transistor array 640(2) will be applied to the substrate 620, such that the sources and drains are in respective electrical contact with the resistive touch region 630 and the second lead 650(2) (see transistor array 92(2) in FIG. 5). Similarly, the bottom transistor array 640(4) will be applied to the substrate 620, such that the sources and drains are in respective electrical contact with the resistive touch region 630 and the second lead 650(2) (see transistor array 92(4) in FIG. 5). As a result of these specific connections, the sources of the transistor arrays 640(1) and 640(3) will remain energized, and the drains of the transistor arrays 640(2) and 640(4) will remain grounded. The current will flow across the resistive touch region 630 in the desired orthogonal directions, in the same manner described in the touchscreen 90 of FIG. 5, when the control lead pair 660(1) and 660(2) and the control lead pair 660(3) and 660(4) are alternately energized and grounded.

Like the diode arrays 240, the transistor arrays 640 are applied to the touchscreen substrate 620 as transistor tape strips. For example, FIG. 33 illustrates a transistor strip 640 that comprises an insulative tape strip 665 composed of a suitable material, such as polyester (e.g., Mylar®) or polyimide (e.g., Kapton®), and a plurality of transistors, and specifically standard surface mounted FETs 645, mounted along the length of the tape strip 665. Each transistor 645 comprises a source terminal 670, drain terminal 685, and a gate terminal 680. The diode strip 640 further comprises a first and second electrically conductive traces 690 and 695 that extend along the length of the tape strip 665.

In the transistor strip 640 illustrated in FIG. 33, the source terminal 670 of each transistor 645 is soldered to the conductive trace 690, the gate terminal 680 of each transistor 645 is soldered to the conductive trace 695, and the drain terminal 670 of each transistor 645 is exposed, so that it can be soldered or glued to the resistive touch region 630 of the substrate 620. The drain terminals 685 extend over the edge of the tape strip 665 to provide clearance for mounting to the exposed touch region 630. Alternatively, holes or vias can be provided through the tape strip 665 in the same manner illustrated in the diode strip 240 of FIG. 9, so that the drain terminals 685 can be connected to the resistive touch region 630 through the holes or vias. The transistor strip 640 can be applied to the substrate 620 along the left and top peripheral edges of the resistive touch region 630 to form the left and top transistor arrays 640(1) and 640(3). A transistor strip similar to the transistor strip 640 illustrated in FIG. 33, with the exception that the source and drain terminals are switched, can be applied to the substrate 620 along the right and bottom peripheral edges of the resistive touch region 630 to form the right and bottom transistor arrays 640(2) and 640(4). The transistor strip 640 may optionally comprise additional electrically conductive traces (not shown), e.g., in order to sense temperature dependent voltage drops across the transistors in a similar manner accomplished in the diode arrays illustrated in FIG. 4.

Although the transistors in the transistor strip 640 of FIG. 33 are illustrated and described as surface mounted transistors, transistor strips with thin-film transistors can also be used. For example, FIGS. 34-42 illustrate a process for fabricating and mounting a transistor strip 740 onto a touchscreen substrate using conductive polymer technology.

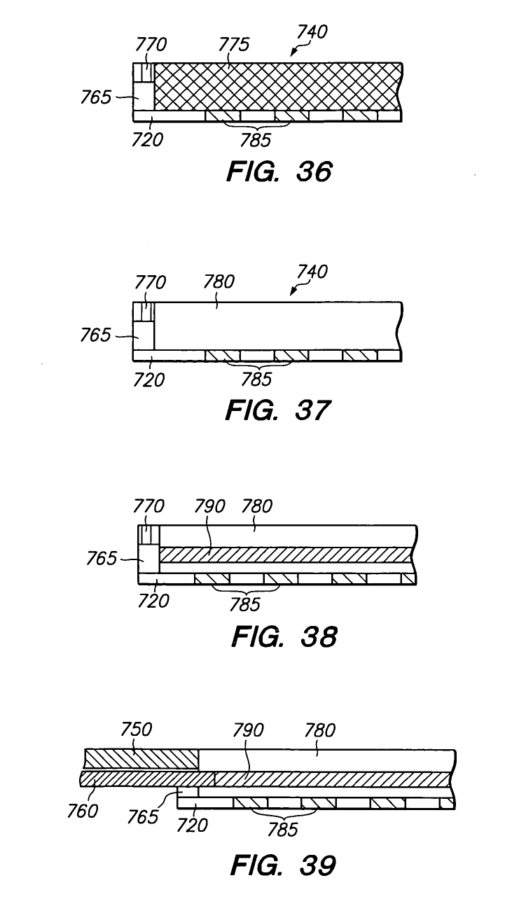

First, an insulative layer 765, such as, e.g., silicone, is deposited onto a flexible insulative layer 720, such as polyester (e.g., Mylar®) or polyimide (e.g., Kapton®) (FIGS. 34 and 41a). Next, a layer of metal, e.g., gold, is deposited on the insulative layer 765 to form an outer electrode 770 and inner electrodes 785 (shown in FIGS. 35 and 41a). Next, a layer of conductive polymer 775 is deposited over the metal layer 770 (FIGS. 36 and 41a). In the preferred embodiment, the conductive polymer layer 775 is composed of regio-regular poly(3-hexyl-thiophene). Then, another layer of insulative material 780 is deposited over the conductive polymer layer 775 (FIGS. 37 and 41a), and another layer of metal 790, e.g., gold, is deposited along the center of the insulative material 780 to serve as the gates of the transistor strip 740 (FIGS. 38 and 41a).

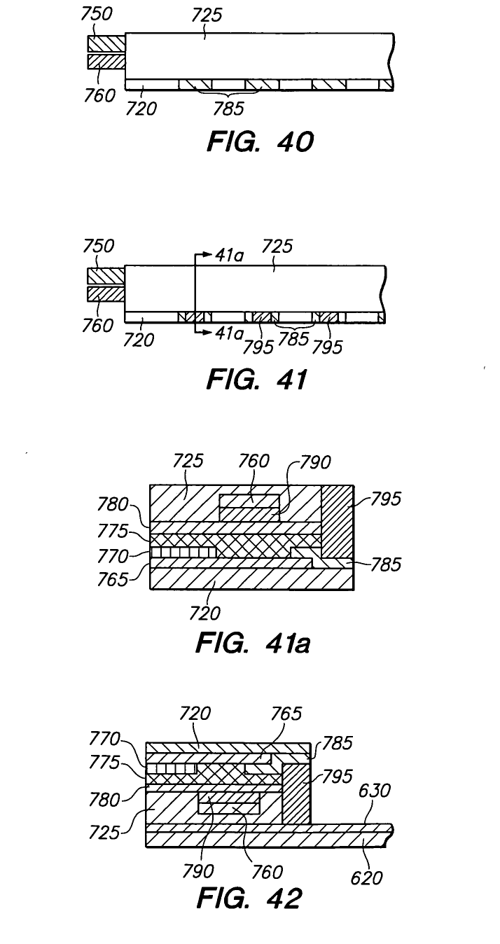

Next, electrically conductive leads 750 and 760, e.g., copper tape or wire, are soldered or otherwise bonded to the respective outer electrode layer 770 and gate layer 790 (FIGS. 39 and 41a). Then, another flexible insulative layer 725, such as, polyimide, is applied over the subassembly (FIGS. 40 and 41a). Alternatively, the subassembly can be encapsulated using a suitable material, such as electrical grade epoxy resin. In this case, the flexible insulative layer 725 serves as both an insulator and an encapsulator. As illustrated in FIG. 39, a portion of the inner electrode layer 785 is left exposed. Terminals 795 can then be fabricated onto the exposed portions of the inner electrode layer 785 using a suitable electrically conductive material, such as copper tape, conductive tape/gel, or lead solder (FIGS. 41 and 41a). Next, the transistor strip 745 is mounted onto the resistive touch region 630 of the substrate 620 using a suitable adhesive (FIG. 42).

As can be seen in FIG. 42, the inner electrode layer 785 is electrically connected to the resistive touch region 630 via the terminals 795. If the transistor strip 745 is used as a left or top transistor array, the terminals 795 will serve as drain terminals, and if the transistor strip 745 is used as a right or bottom transistor array, the terminals 790 will serve as source terminals.

Further details regarding the fabrication of transistor arrays using conductive polymer technology are set forth in further detail in U.S. patent application Ser. No. ______ (Attorney docket number ELG056 US1), which is expressly incorporated herein by reference.

Although the transistor arrays 640 and 740 have been described as comprising a single semiconductor material, it should be noted that transistor arrays can be fabricated using two types of semiconductor material (a p-type semiconductor material and an n-type semiconductor material.) For example, transistors arrays formed from bipolar transistors, which utilize two types of semiconductor material, can be used. For example, the previously described transistor array 740 can use two conductive polymer layers between collector and emitter terminals. Or the transistor strip 640 can carry surface mounted bipolar transistors.

Although particular embodiments of the present invention have been shown and described, it should be understood that the above discussion is not intended to limit the present invention to these embodiments. Those of ordinary skill in the art will appreciate that various changes and modifications may be made without departing from the spirit and scope of the present invention. Thus, the present invention is intended to cover alternatives, modifications, and equivalents that may fall within the spirit and scope of the present invention as defined by the claims.

1. A method of manufacturing a touch sensor, comprising:
providing a substrate having a resistive touch region;
providing a tape strip with a plurality of devices, each of the devices having first and second terminals and being configured to allow electrical current conduction from the first terminal to the second terminal in a first state, and prevent electrical current conduction from the second terminal to the first terminal in a second state; and
securing the tape strip along an edge of the resistive touch region, wherein one of the first and second terminals of the devices are in electrical contact with the resistive touch region.

2. The method of claim 1, further comprising securing an electrically conductive lead to the other of the first and second terminals.

3. The method of claim 1, wherein the devices are surface mounted devices.

4. The method of claim 1, wherein the devices are thin-film devices.

5. The method of claim 4, wherein each of the devices comprises at least one layer of conductive polymer.

6. The method of claim 1, wherein the tape strip is bonded to the substrate.

7. The method of claim 1, wherein the resistive touch region comprises a resistive layer, the touch sensor further comprising a coversheet disposed over the resistive touch region.

8. The method of claim 1, wherein the resistive touch region comprises a resistive layer and a dielectric layer disposed over the resistive layer.

9. A method of manufacturing a touch sensor, comprising:
providing a substrate having a resistive touch region with first and second oppositely disposed edges and third and fourth oppositely disposed edges;
providing four tape strips, each with a plurality of devices, each of the devices having first and second terminals and being configured to allow electrical current conduction from the first terminal to the second terminal when in a first state, and prevent electrical current conduction from the second terminal to the first terminal when in a second state;
securing two of the tape strips along the respective first and third edges of the resistive touch region, wherein the second terminals of the devices of the two tape strips are in electrical contact with the resistive touch region; and
securing the other two of the tape strips along the respective second and fourth edges of the resistive touch region, wherein the first terminals of the devices of the other two tape strips are in electrical contact with the resistive touch region.

10. The method of claim 9, further comprising:
electrically coupling at least one electrically conductive lead to the first terminals of devices not connected to the touch region; and
electrically coupling at least another electrically conductive lead to the second terminals of devices not connected to the touch region.

11. The method of claim 9, wherein the devices are surface mounted devices.

12. The method of claim 9, wherein the devices are thin-film devices.

13. The method of claim 12, wherein each of the devices comprises at least one layer of conductive polymer.

14. The method of claim 9, wherein tape strips are bonded to the substrate.

15. The method of claim 9, wherein the tape strips are cut from a tape reel.

16. The method of claim 9, wherein the tape strips are cut from a single tape reel.

17. The method of claim 9, wherein the tape strips are cut from a sheet.

18. The method of claim 9, wherein the resistive touch region comprises a resistive layer, the touch sensor further comprising a coversheet disposed over the resistive touch region.

19. The method of claim 9, wherein the resistive touch region comprises a resistive layer and a dielectric layer disposed over the resistive layer.

20. Reversible diode tape, comprising:
a first electrically insulative layer;
a layer of spaced apart anodes disposed on the first electrically insulative layer;
a p-type semiconductor layer disposed on the anode layer;
an n-type semiconductor layer disposed on the p-type semiconductor layer;
a layer of spaced apart cathodes disposed on the n-type semiconductor layer, wherein the cathodes are substantially aligned with the anodes to discretely form diodes; and
a second electrically insulative layer disposed on the cathode layer.

21. The tape of claim 20, further comprising:
a layer of exposed anode terminals respectively disposed on the anode layer; and
a layer of exposed cathode terminals respectively disposed on the layer of cathodes.

22. The tape of claim 21, wherein the tape has opposite edges, and the anode and cathode terminals respectively extend along the opposite tape edges.

23. The tape of claim 20, further comprising:
a first electrically conductive trace connecting the anodes; and
a second electrically conductive trace connecting the cathodes.

24. The tape of claim 20, wherein the p-type and n-type semiconductor layers are composed of a conductive polymer.

25. The tape of claim 24, wherein the p-type semiconductor layer is composed of doped polythiophene, poly (3,4-ethylenedioxythiophene)-poly(4-styrenesulfonate).

26. The tape of claim 25, wherein the n-type semiconductor layer is composed of doped poly(2-methoxy,5-(2′-ethyl-hexyloxy)-1,4-phenylene vinylene).
